(19) United States
(12) Patent Application Publication
(10) Pub. No.: US 2014/0208075 A1
(43) Pub. Date: Jul. 24, 2014

(54) SYSTEMS AND METHOD FOR UNBLOCKING A PIPELINE WITH SPONTANEOUS LOAD DEFERRAL AND CONVERSION TO PREFETCH

(71) Applicant: James Earl McCormick, JR., Fort Collins, CO (US)

(72) Inventor: James Earl McCormick, JR., Fort Collins, CO (US)

(21) Appl. No.: 13/995,904

(22) PCT Filed: Dec. 20, 2011
(86) PCT No.: PCT/US11/66215

§ 371 Date: Jun. 19, 2013

(51) Int. Cl. G06F 9/38

(52) U.S. Cl. CPC G06F 9/3812
USPC 712/207

(57) ABSTRACT

Apparatuses, systems, and a method for providing a processor architecture with a control speculative load are described. In one embodiment, a computer-implemented method includes determining whether a speculative load instruction encounters a long latency condition, spontaneously deferring the speculative load instruction if the speculative load instruction encounters the long latency condition, and initiating a prefetch of a translation or of data that requires long latency access when the speculative load instruction encounters the long latency condition. The method further includes reaching a check instruction, which resteers to recovery code that executes a non-speculative version of the load.

### TECHNICAL FIELD

Embodiments of the invention relate to unblocking a pipeline with spontaneous load deferral and conversion to prefetch.

### BACKGROUND

Processor performance has been increasing faster than memory performance for a long time. This growing gap between processor and memory performance means that today most processors spend much of their time waiting for data. Modem processors often have several levels of on-chip and possibly off-chip caches. These caches help reduce data access time by keeping frequently accessed lines in closer, faster caches. Data prefetching is the practice of moving data from a slower level of the cache/memory hierarchy to a faster level before the data is needed by software. Long latency loads can block forward progress in a computer pipeline. For instance, when a load misses the data translation lookaside buffer (TLB), it may block the pipeline while waiting for a hardware page walker to find and insert a data translation in the TLB. Another potential pipeline blocking scenario in an in-order pipeline is when an instruction attempt to use a load target register before that potentially long latency load completed.

### BRIEF DESCRIPTION OF THE DRAWINGS

The various embodiments of the present invention are illustrated by way of example, and not by way of limitation, in the figures of the accompanying drawings and in which:

FIG. 1 illustrates a flow diagram of one embodiment for a computer-implemented method of spontaneously deferring speculative instructions of an in-order pipeline in accordance with one embodiment of the invention;

FIG. 2 illustrates a processor architecture having a non-blocking execution in accordance with one embodiment of the invention;

FIG. 3 illustrates a processor architecture having a recovery code execution in accordance with one embodiment of the invention;

FIG. 4 illustrates a processor architecture having a non-blocking execution in accordance with another embodiment of the invention;

FIG. 5 illustrates a processor architecture having a recovery code execution in accordance with another embodiment of the invention;

FIG. 6 is a block diagram of a system in accordance with one embodiment of the invention;

FIG. 7 is a block diagram of a second system in accordance with an embodiment of the invention;

FIG. 8 is a block diagram of a third system in accordance with an embodiment of the invention; and

FIG. 9 illustrates a functional block diagram illustrating a system implemented in accordance with one embodiment of the invention.

### DETAILED DESCRIPTION

Systems and a method for spontaneously deferring a speculative instruction are described. In one embodiment, a method spontaneously defers a speculative instruction if the instruction encounters a long latency condition while still allowing the load to initiate a hardware page walk. Embodiments of this invention allow the main pipeline to make forward progress in any case where the pipeline could be blocked waiting for a long latency speculative load.

In the following description, numerous specific details such as logic implementations, sizes and names of signals and buses, types and interrelationships of system components, and logic partitioning/integration choices are set forth in order to provide a more thorough understanding. It will be appreciated, however, by one skilled in the art that embodiments of the invention may be practiced without such specific details. In other instances, control structures and gate level circuits have not been shown in detail to avoid obscuring embodiments of the invention. Those of ordinary skill in the art, with the included descriptions, will be able to implement appropriate logic circuits without undue experimentation.

In the following description, certain terminology is used to describe features of embodiments of the invention. For example, the term “logic” is representative of hardware and/or software configured to perform one or more functions. For instance, examples of “hardware” include, but are not limited or restricted to, an integrated circuit, a finite state machine or even combinatorial logic. The integrated circuit may take the form of a processor such as a microprocessor, application specific integrated circuit, a digital signal processor, a micro-controller, or the like. The interconnect between chips each could be point-to-point or each could be in a multi-drop arrangement, or some could be point-to-point while others are a multi-drop arrangement.

The processor architecture (e.g., Itanium® architecture) supports speculative loads via the ld.s and chk.s instructions. A control speculative load is one that has been hoisted by the code generator above a preceding branch. In other words, it is executed before it is known to be needed. Such loads could generate faults that would not occur when the code is executed in original program order. In the processor architecture (e.g., Itanium® architecture), in order to control speculate a load, the load is converted by the code generator into a ld.s instruction and a chk.s instruction. The ld.s is then hoisted to the desired location while the chk.s is left in the original location. If the ld.s instruction encounters a long latency condition (e.g., fault caused by out of order execution, illegal location, no available translation, etc.), instead of faulting it sets a special bit in its target register called a Not A Thing (NAT). This is called “deferring” the fault. This NAT bit is propagated from source registers to destination registers by most instructions. When a NAT bit is consumed by a chk.s instruction, the chk.s causes a resteer to recovery code which then executes a non-speculative load that takes the fault in program order. The ld.s instruction can be thought of as a data prefetch into a target register. Other processor architecture features such as architectural support for predication and data speculation also help to increase the effectiveness of software data prefetching.

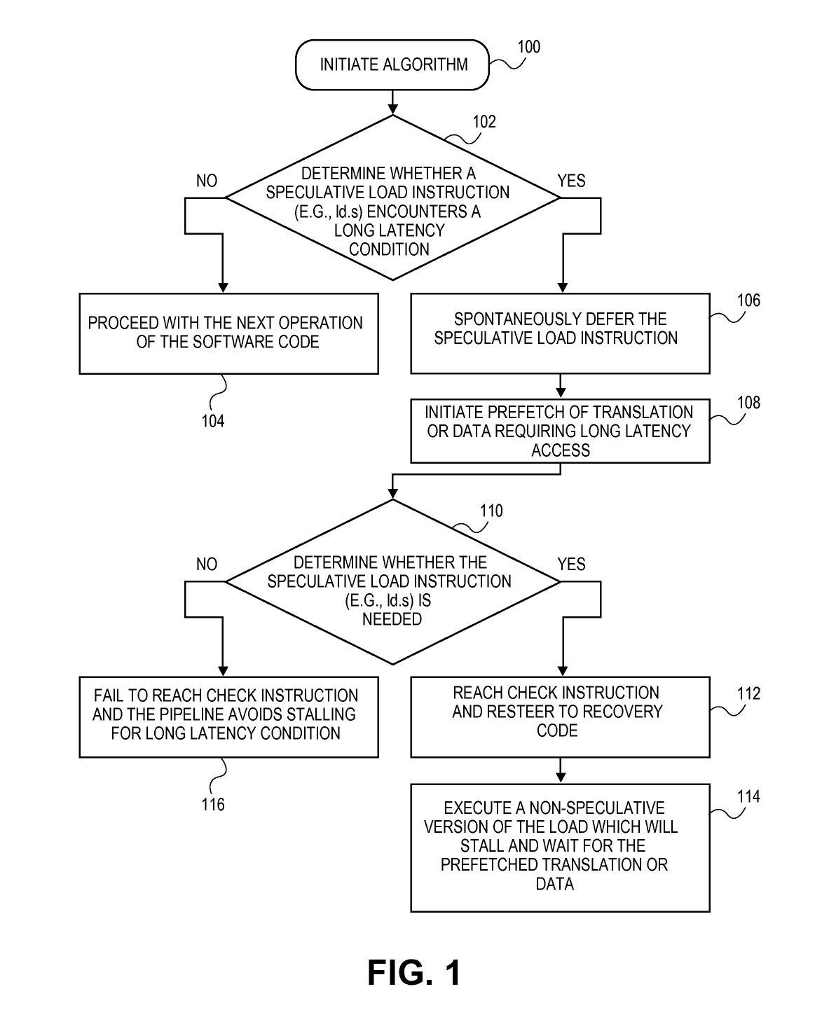

FIG. 1 illustrates a flow diagram of one embodiment for a computer-implemented method 100 of spontaneously deferring speculative instructions of an in-order pipeline in accordance with one embodiment. The method 100 is performed by processing logic that may comprise hardware (circuitry, dedicated logic, etc.), software (such as is run on a general purpose computer system or a dedicated machine or a device), or a combination of both. In one embodiment, the method 100 is performed by processing logic associated with the architecture discussed herein.

At block 100, the processing logic initiates a software algorithm. At block 102, the processing logic determines whether a speculative load instruction (e.g., ld.s) encounters a long latency condition. For example, a long latency condition may include the load missing a data translation lookaside buffer (TLB) or missing a data cache (e.g., mid-level data cache (MLD)). A TLB is a CPU cache that memory management hardware uses to improve virtual address translation speed. A TLB is used to map virtual and physical address spaces, and it is ubiquitous in any hardware which utilizes virtual memory. The TLB is typically implemented as content-addressable memory (CAM). The CAM search key is the virtual address and the search result is a physical address. If the requested address is present in the TLB, the CAM search yields a match quickly and the retrieved physical address can be used to access memory. This is called a TLB hit. If the requested address is not in the TLB, it is a miss, and the translation proceeds by looking up the page table in a process called a page walk. The page walk may be a time consuming process, as it involves reading the contents of multiple memory locations and using them to compute the physical address. After the physical address is determined by the page walk, the virtual address to physical address mapping is entered into the TLB.

For no long latency condition (e.g., a TLB hit), the processing logic proceeds with the next operation of the software code algorithm at block 104. At block 106, the processing logic of the present design spontaneously defers the speculative load instruction if it encounters a long latency condition (e.g., misses the data buffer, TLB miss). The processor architecture allows a ld.s to generate a NAT bit for performance reasons. This is called “spontaneous deferral.” At block 108, the processing logic initiates a prefetch of a translation or data requiring long latency access. At block 110, the processing logic determines whether or not the speculative load instruction (e.g., ld.s) is needed by executing the code. If the execution path through the code leads to execution of the corresponding check instruction (e.g., chk.s), then the load was needed. If so, then the corresponding check instruction (e.g., chk.s) will be reached and will resteer to recovery code at block 112. The recovery code will execute a non-speculative version of the load which will stall and wait for prefetched translation or data at block 114. If, however, the speculative load turns out to not be needed, the corresponding check instruction will not be reached and the pipeline avoids stalling for the long latency condition at block 116. This feature makes ld.s instructions, which can be thought of as prefetches into registers, more effective.

As described above, the present design can spontaneously defer a speculative load instruction that misses the mid level data cache (MLD). The reasoning is similar to the case of the TLB miss. A load that misses the MLD is going to have a long latency. Without spontaneous deferral, a use of this load's target register will stall the pipeline. Use of the load's target register can actually be a write or a read. Spontaneous deferral avoids the long latency. However, the present design converts the speculative load into a data prefetch and sends it on to the next cache level (LLC) in case the speculative load was actually needed. Once again, if the speculative load was needed a chk.s instruction will resteer to recovery code.

The processor architecture of the present disclosure includes a hardware page walker that can look up translations in the virtual hash page table (VHPT) in memory and insert them into the TLBs. On previous processors (e.g., Itanium® processors), when a speculative load missed the data TLB and initiated a hardware page walk, the pipeline was stalled for the duration of the hardware page walk. Also, a useless speculative load can stall the pipeline for a long time. Since a speculative load instruction is inherently speculative, it can uselessly attempt to reference a page which would never be referenced by a non-speculative instruction. It is worth noting that always dropping the speculative load instruction that misses the data TLB is also not a good option because sometimes (i.e., more often than not) the speculative load is useful. The present design can be conceptualized as an inexpensive, software visible, out-of-order execution for an in-order pipeline.

Out-of-order pipelines avoid stalling on uses of load target registers by enabling software transparent out-of-order execution of non-dependent instructions that follow the use. This software transparent out-of-order execution requires significant hardware resources including register duplication and dependency checking.

Out-of-order pipelines are more expensive than in-order pipelines, and the out-of-order pipelines take away some of the ability of software to optimize code execution. The present design provides the benefit of avoiding some pipeline stalls in an in-order pipeline.

Also, some previous approaches tried to use spontaneous deferral to avoid blocking the pipeline but at the cost of dropping the memory accesses. This actually resulted in performance degradations.

The present design provides the ability to do a hardware page walk concurrent with a non-stalled pipeline. Also, the present design works with data access hints that can turn this technique on and off on a load by load basis. The reason for this is that in a few limited cases (e.g., indirect prefetching) it might be better for the speculative load to block the pipeline than to spontaneously defer with a NAT bit. The present design with data access hints does provide significant performance improvements.

Embodiments of the present design can be implemented with the following software code execution examples:

C like code

if (ptr != NULL) { // avoid dereferencing a NULL pointer that points to
nothing
x = *ptr; // get value at pointer
} else {
x = 0; // no value at pointer so set x to 0
}
MORE_CODE:
y = y + x; // accumulate x in y

A simple translation into (Itanium-like) assembly code follows:

movl ra = PTR;;
movl rn = NULL;;
cmp.eq p7,p6 = ra, rn;; // avoid dereferencing
(p7) br ELSE // a NULL pointer
ld rx = [ra] // get value at pointer (non-speculative load)
br MORE_CODE
ELSE:
movl rx = 0;; // no value at pointer so set x to 0
P38745PCT
MORE_CODE:
add ry = ry, rx // accumulate x in y

In one embodiment, a more optimized translation into (Itanium-like) assembly code might use control speculation to move the load earlier to help hide some latency:

L1: movl ra = PTR;;
L2: ld.s rx = [ra] // get value at pointer (speculative load - spontaneously
defer
on long latency)
L3: movl rn = NULL;;
L4: cmp.eq p7,p6 = ra, rn;; // avoid dereferencing
L5: (p7) br ELSE // a NULL pointer
L6: chk.s rx, RECOVERY_CODE // resteer to recovery code if rx
contains NAT
L7: br MORE_CODE
RECOVERY_CODE:
L8: ld rx = [ra] // get value at pointer (non-speculative load)
L9: br MORE_CODE
ELSE:
L10: mov1 rx = 0;; // no value at pointer so set x to 0
MORE_CODE:
L11: add ry = ry, rx // accumulate x in y

The following scenarios apply to the above optimized code:
A) PTR is NULL and translation is not in TLB
B) PTR is NULL and translation is in TLB but data is not in fast cache
C) PTR is not NULL and translation is not in TLB
D) PTR is not NULL and translation is in TLB but data is not in fast cache
Previous processors would execute the code in each of the scenarios as follows:
A) L1, L2 (long stall (e.g., 30 cycles, 100 cycles) due to blocking hardware page walk that blocks the pipeline), L3, L4, L5, L10, L11
B) L1, L2, L3, L4, L5, L10 (long stall waiting for speculative load to write rx), L11
C) L1, L2 (long stall (e.g., 30 cycles, 100 cycles) due to blocking hardware page walk that blocks the pipeline), L3, L4, L5, L6, L7, L11
D) L1, L2, L3, L4, L5, L6, L7, L11 (long stall waiting for speculative load to write rx) For cases A and C, a pipeline blocking execution occurs from a speculative load instruction (e.g., ld.s rx←ra) that loads address ra into rx, which may be stored in a register file. First, processing logic attempts to find a translation for a virtual address associated with rx in a first TLB hierarchy (operation 1). For cases A and C, rx misses the first TLB hierarchy and this causes a page walk to the second TLB hierarchy, which has the translation for the virtual address of rx (operation 2). Thus, the second TLB hierarchy returns the physical address, PA(rx), that results from translating the virtual address in rx to the first TLB hierarchy (operation 3). The processing logic then sends the PA(rx) to a first memory hierarchy (e.g., fast cache) (operation 4), which sends the data associated with PA(rx) to the register file (operation 5). The speculative load instruction has prefetched data to the register file. However, a long stall occurs due to the hardware page walk that is caused by the miss of the first TLB hierarchy. The long stall blocks the pipeline.

For cases B and D, a long stall occurs due to waiting for a speculative load to write rx. The long stall blocks the pipeline. First, processing logic attempts to find a translation of a virtual address associated with rx in a first TLB hierarchy (operation 1). For cases B and D, rx hits the first TLB hierarchy and this causes the translation for the virtual address of ra, PA(rx), to be sent to a first memory hierarchy (operation 2). This hierarchy (e.g., fast cache) does not have the data, thus the processing logic then sends the PA(rx) to a second memory hierarchy (e.g., fast cache) (operation 3). The processing logic sends the data associated with PA(rx) to the first memory hierarchy (operation 4). This data is then written to the register file (operation 5). The speculative load instruction has prefetched data to the register file. However, a long stall occurs due to waiting for the speculative load to write rx. The long stall blocks the pipeline.

Embodiments of the invention, can execute the code in each of these scenarios as follows:
A) L1, L2 (issue non-blocking hardware page walk, spontaneously defer load, NO stall), L3, L4, L5, L10, L11 [speculative load is not needed]
B) L1, L2 (issue prefetch, spontaneously defer load, NO stall), L3, L4, L5, L10, L11 [speculative load is not needed]
C) L1, L2 (issue non-blocking hardware page walk, spontaneously defer load, NO stall), L3, L4, L5, L6, L8 (somewhat shorter long stall (e.g., 24 cycles) due to blocking hardware page walk), L9, L11 [speculative load is needed]
D) L1, L2 (issue prefetch, spontaneously defer load, NO stall), L3, L4, L5, L6, L8, L9, L11 (somewhat shorter long stall waiting for speculative load to write rx) [speculative load is needed]

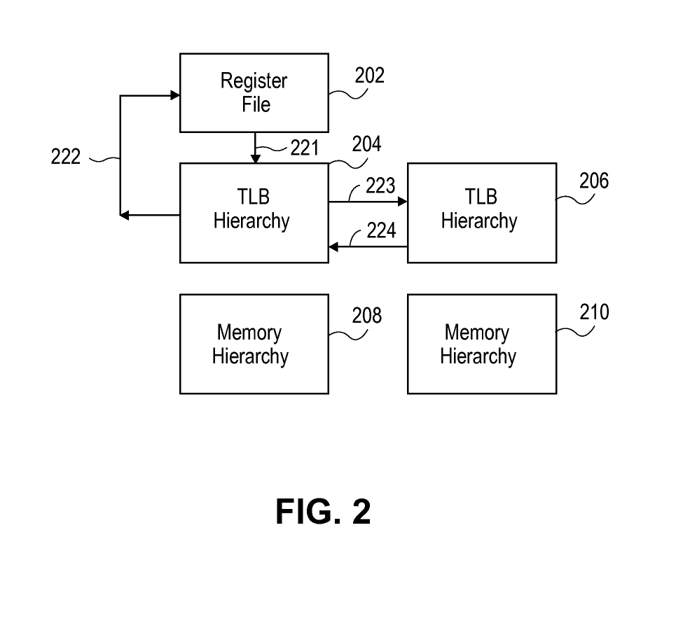

FIGS. 2-5 illustrate a processor architecture having a non-blocking execution in accordance with one embodiment. FIG. 2 illustrates a processor architecture 200 having a non-blocking execution in accordance with one embodiment. For cases A and C, a non-blocking execution occurs from a speculative load instruction (e.g., ld.s rx←ra) that loads address ra into rx, which may be stored in a register file 202. The processing logic attempts to find a translation for a virtual address associated with rx in a first TLB hierarchy 204 (operation 221). For cases A and C, rx misses the first TLB hierarchy 204 and this causes a spontaneous deferral (NAT bit) to be set in rx of the register file 202 (operation 222). Also, the TLB miss causes a page walk to the second TLB hierarchy 206 (operation 223), which has the translation for the virtual address of rx. Thus, the processing logic causes the second TLB hierarchy 206 to send the physical address, PA(rx), which results from translating the virtual address in rx, to the first TLB hierarchy 204 (operation 224). The potential long stall due to the long latency of the speculative load instruction has been spontaneously deferred with the NAT bit set in the register file 202. The pipeline is not stalled because of the spontaneous deferral. The memory hierarchy 208 and 210 are not accessed in this example.

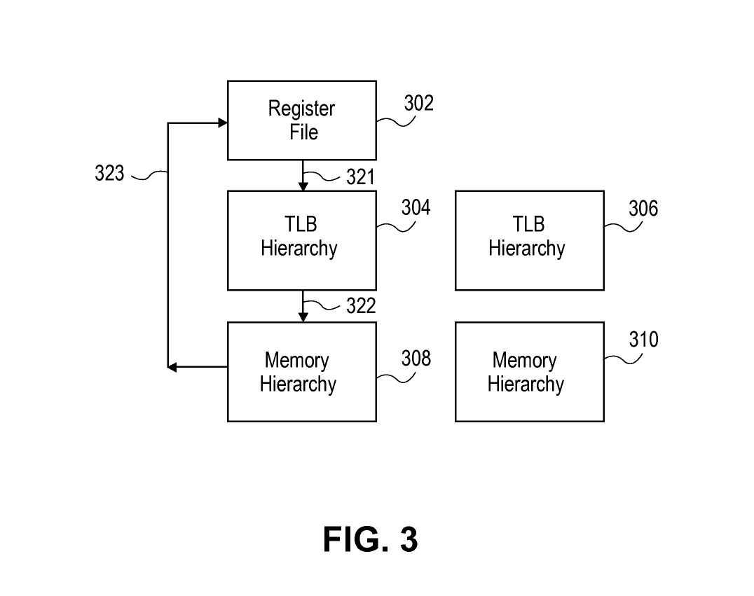

FIG. 3 illustrates a processor architecture 300 having a recovery code execution in accordance with one embodiment. Elements in FIG. 3 may be the same or similar to like elements that are illustrated in FIG. 2. For example, register file 202 may be the same as register file 302 or similar to register file 302. Execution of a check (e.g., chk.s) instruction initiates a recovery code execution that performs a non-speculative load (e.g., ld rx←ra). For cases A and C, the processing logic attempts to find a translation for a virtual address associated with rx, which is stored in a register file 302, in a first TLB hierarchy 304 (operation 321). For cases A and C and execution of recovery code, rx hits the first TLB hierarchy and this causes the first TLB hierarchy to send the physical address, PA(rx), which results from translating the virtual address in rx, to the first memory hierarchy 308 (operation 322). Then, the processing logic causes the first memory hierarchy to send data from PA(rx) in memory hierarchy 308 to the register file 302 (operation 323). The second TLB hierarchy 306 and second memory hierarchy 310 are not accessed in this example.

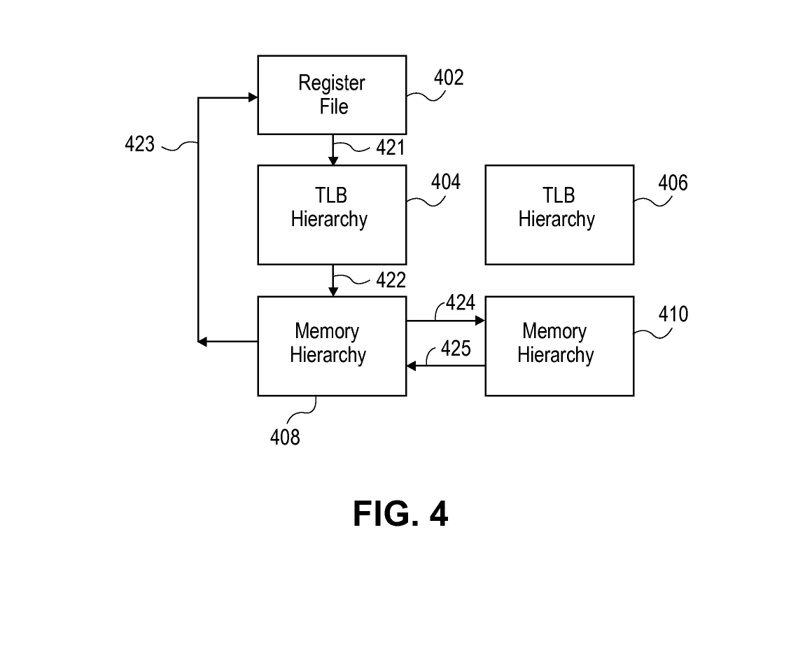

FIG. 4 illustrates a processor architecture 400 having a non-blocking execution in accordance with one embodiment. For cases B and D, a non-blocking execution occurs based on a speculative load instruction (e.g., ld.s rx←ra) that loads address ra into rx, which may be stored in a register file 402. Processing logic attempts to find a translation for a virtual address associated with rx in a first TLB hierarchy 404 (operation 421). For cases B and D, rx hits the first TLB hierarchy and this causes the processing logic to send the physical address, PA(rx), that results from translating the virtual address in rx from the first TLB hierarchy 404 to the first memory hierarchy 408 (operation 422). However, the memory hierarchy 408 does not have the PA(rx). Thus, this causes a spontaneous deferral with a NAT bit being set in the register file 402 (operation 423). The memory hierarchy 410 does have the PA(rx) (operation 424) and processing logic causes the memory hierarchy 310 to send data associated with PA(rx) to the memory hierarchy 408 (operation 425). The potential long stall due to the long latency of the speculative load instruction has been spontaneously deferred with the NAT bit set in the register file. The TLB hierarchy 406 is not accessed in this example.

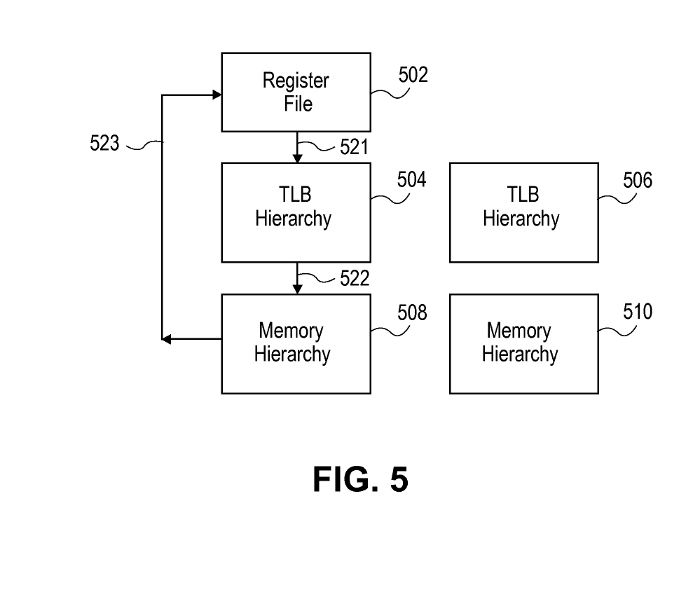

FIG. 5 illustrates a processor architecture 500 having a recovery code execution in accordance with one embodiment. Elements in FIG. 5 may be the same or similar to like elements that are illustrated in FIG. 4 (e.g., register file 402, register file 502). Execution of a chk.s instruction initiates a recovery code execution that performs a non-speculative load. For cases B and D, first, processing logic attempts to find a translation for a virtual address associated with rx in a first TLB hierarchy 504 (operation 521). A register file 502 stores rx.

For cases B and D and execution of recovery code, rx hits the first TLB hierarchy and this causes the first TLB hierarchy to send the physical address, PA(rx), which results from translating the virtual address in rx, to the first memory hierarchy 508 (operation 522). Then, the processing logic causes the first memory hierarchy to send data associated with PA(rx) to the register file 502 (operation 523). The second TLB hierarchy 506 and second memory hierarchy 510 are not accessed in this example.

In one embodiment, a processor architecture includes a register file, a first translation lookaside buffer (TLB) coupled to the register file. The first TLB includes a number of ports for mapping virtual addresses to physical addresses. A second TLB is coupled to the first TLB. The second TLB performs a hardware page walk that is initiated when the load speculative instruction misses the first TLB. Cache storage stores data including data associated with physical address that is associated with the load speculative instruction. Processing logic is configured to determine whether a speculative load instruction encounters a long latency condition, to spontaneously defer the speculative load instruction by setting a bit in the register file if the speculative load instruction encounters the long latency condition, and to initiate a prefetch of the missing translation or cache line data via a hardware page walk or cache line prefetch operation. The “spontaneous” part of the “spontaneous deferral” refers to the fact that the present design spontaneously defers a speculative load even though a fault does not occur. Thus, the deferral mechanism that was originally created in order to allow deferral of faults is being used to defer long latency operations as well.

The processing logic is further configured to determine whether the speculative load instruction is needed. The speculative load instruction is associated with a check instruction. Reaching the check instruction implies that the speculative load was needed and thus the check instruction resteers to recovery code. The check instruction is not executed if the speculative load is not needed and the processor architecture avoids stalling for the hardware page walk.

The processor architecture of the present design includes data prefetching features (e.g., control speculative loads). A micro-architecture is created that enables these prefetching mechanisms with minimal cost and complexity and would easily enable the addition of other prefetching mechanisms as well.

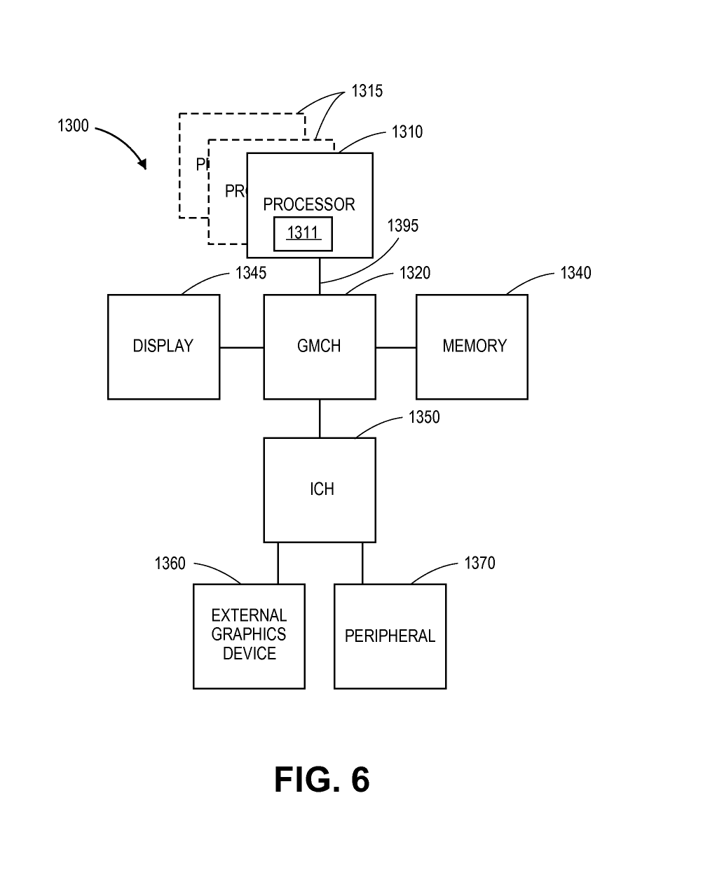

FIG. 6 illustrates that the GMCH 1320 may be coupled to the memory 1340 that may be, for example, a dynamic random access memory (DRAM). The DRAM may, for at least one embodiment, be associated with a non-volatile cache.

The GMCH 1320 may be a chipset, or a portion of a chipset. The GMCH 1320 may communicate with the processor(s) 1310, 1315 and control interaction between the processor(s) 1310, 1315 and memory 1340. The GMCH 1320 may also act as an accelerated bus interface between the processor(s) 1310, 1315 and other elements of the system 1300. For at least one embodiment, the GMCH 1320 communicates with the processor(s) 1310, 1315 via a multi-drop bus, such as a frontside bus (FSB) 1395.

Furthermore, GMCH 1320 is coupled to a display 1345 (such as a flat panel display). GMCH 1320 may include an integrated graphics accelerator. GMCH 1320 is further coupled to an input/output (I/O) controller hub (ICH) 1350, which may be used to couple various peripheral devices to system 1300. Shown for example in the embodiment of FIG. 6 is an external graphics device 1360, which may be a discrete graphics device coupled to ICH 1350, along with another peripheral device 1370.

The processor 1310 may include a processor architecture 1311 (e.g., 200, 300, 400, 500) as discussed herein. Alternatively, additional or different processors may also be present in the system 1300. For example, additional processor(s) 1315 may include additional processors(s) that are the same as processor 1310, additional processor(s) that are heterogeneous or asymmetric to processor 1310, accelerators (such as, e.g., graphics accelerators or digital signal processing (DSP) units), field programmable gate arrays, or any other processor. There can be a variety of differences between the physical resources 1310, 1315 in terms of a spectrum of metrics of merit including architectural, microarchitectural, thermal, power consumption characteristics, and the like. These differences may effectively manifest themselves as asymmetry and heterogeneity amongst the processing elements 1310, 1315. For at least one embodiment, the various processing elements 1310, 1315 may reside in the same die package.

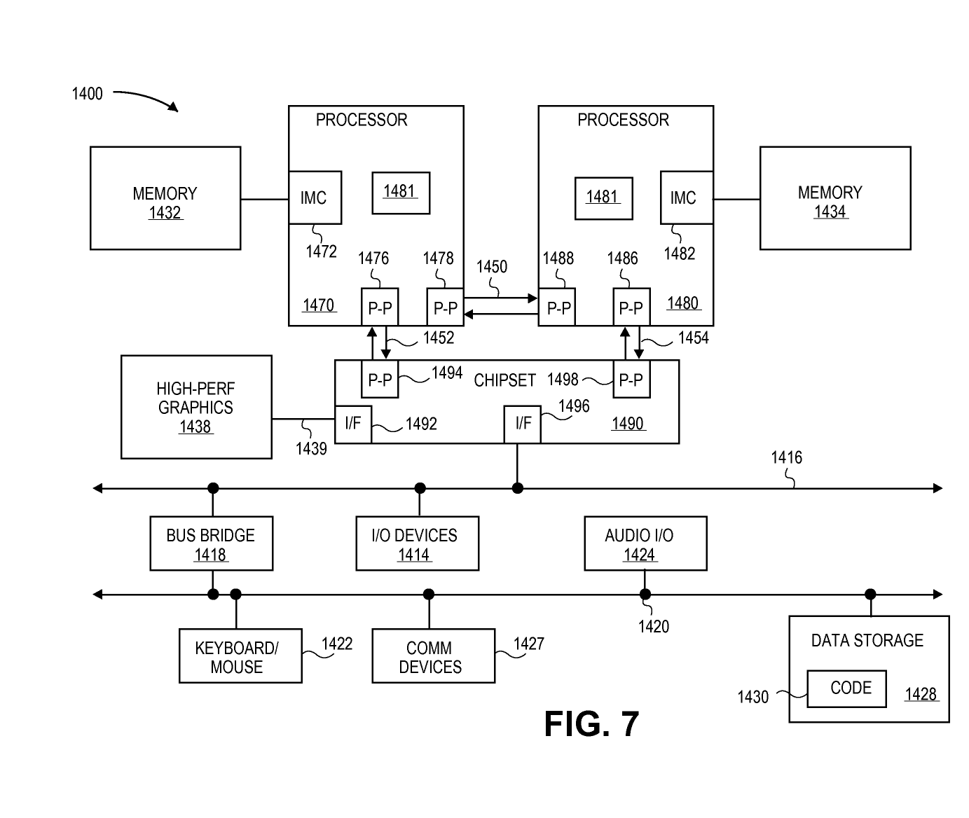

Referring now to FIG. 7, shown is a block diagram of a second system 1400 in accordance with an embodiment of the present invention. As shown in FIG. 7, multiprocessor system 1400 is a point-to-point interconnect system, and includes a first processor 1470 and a second processor 1480 coupled via a point-to-point interconnect 1450. Alternatively, one or more of processors 1470, 1480 may be an element other than a processor, such as an accelerator or a field programmable gate array. While shown with only two processors 1470, 1480, it is to be understood that the scope of embodiments of the present invention is not so limited. In other embodiments, one or more additional processing elements may be present in a given processor.

Processor 1470 may further include an integrated memory controller hub (IMC) 1472 and point-to-point (P-P) interfaces 1476 and 1478. Similarly, second processor 1480 may include a IMC 1482 and P-P interfaces 1486 and 1488. Processors 1470, 1480 may exchange data via a point-to-point (PtP) interface 1450 using PtP interface circuits 1478, 1488. As shown in FIG. 7, IMC's 1472 and 1482 couple the processors to respective memories, namely a memory 1442 and a memory 1444, which may be portions of main memory locally attached to the respective processors. The processors 1470 and 1480 may include a processor architecture 1481 (e.g., 200, 300, 400, 500) as discussed herein.

Processors 1470, 1480 may each exchange data with a chipset 1490 via individual P-P interfaces 1452, 1454 using point to point interface circuits 1476, 1494, 1486, 1498. Chipset 1490 may also exchange data with a high-performance graphics circuit 1438 via a high-performance graphics interface 1439.

A shared cache (not shown) may be included in either processor outside of both processors, yet connected with the processors via P-P interconnect, such that either or both processors' local cache information may be stored in the shared cache if a processor is placed into a low power mode.

Chipset 1490 may be coupled to a first bus 1416 via an interface 1496. In one embodiment, first bus 1416 may be a Peripheral Component Interconnect (PCI) bus, or a bus such as a PCI Express bus or another third generation I/O interconnect bus, although the scope of embodiments of the present invention is not so limited.

As shown in FIG. 7, various I/O devices 1414 may be coupled to first bus 1416, along with a bus bridge 1418 which couples first bus 1416 to a second bus 1420. In one embodiment, second bus 1420 may be a low pin count (LPC) bus. Various devices may be coupled to second bus 1420 including, for example, a keyboard/mouse 1422, communication devices 1426 and a data storage unit 1428 such as a disk drive or other mass storage device which may include code 1430, in one embodiment. Further, an audio I/O 1424 may be coupled to second bus 1420. Note that other architectures are possible. For example, instead of the point-to-point architecture of FIG. 7, a system may implement a multi-drop bus or other such architecture.

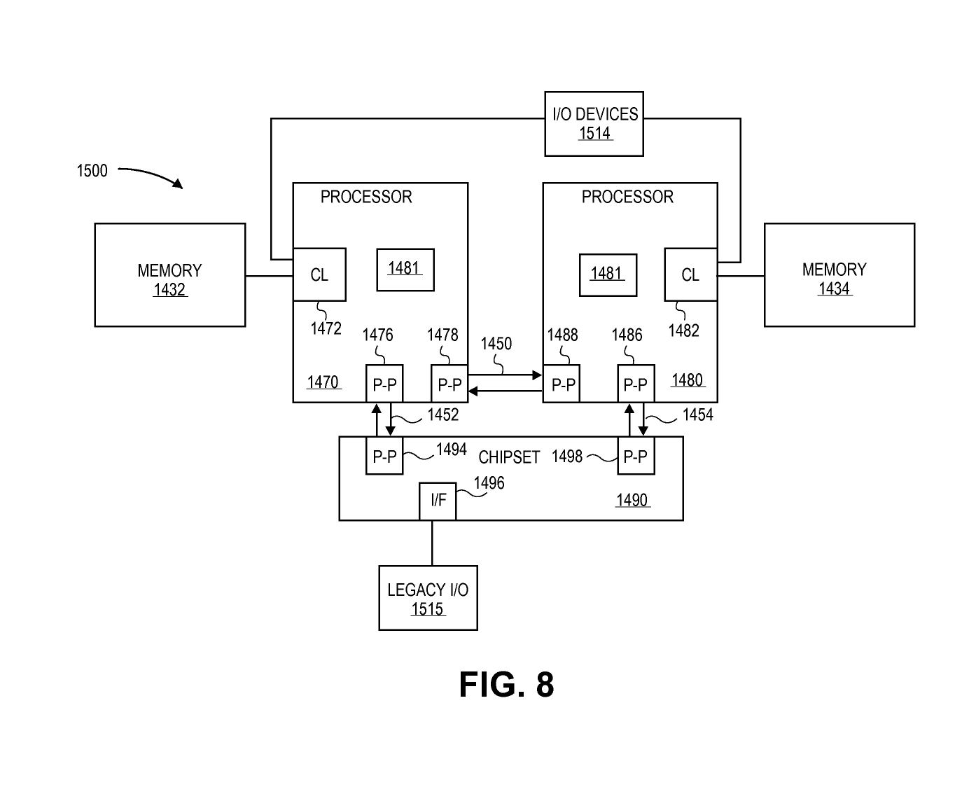

Referring now to FIG. 8, shown is a block diagram of a third system 1500 in accordance with an embodiment of the present invention. Like elements in FIGS. 7 and 8 bear like reference numerals, and certain aspects of FIG. 7 have been omitted from FIG. 8 in order to avoid obscuring other aspects of FIG. 8.

FIG. 8 illustrates that the processing elements 1470, 1480 may include integrated memory and I/O control logic (“CL”) 1472 and 1482, respectively. For at least one embodiment, the CL 1472, 1482 may include memory controller hub logic (IMC) such as that described above in connection with FIGS. 6 and 7. In addition, CL 1472, 1482 may also include I/O control logic. FIG. 8 illustrates that not only are the memories 1442, 1444 coupled to the CL 1472, 1482, but also that I/O devices 1514 are also coupled to the control logic 1472, 1482. Legacy I/O devices 1515 are coupled to the chipset 1490. The processing elements 1470 and 1480 may include a processor architecture 1481 (e.g., 200, 300, 400, 500) as discussed herein.

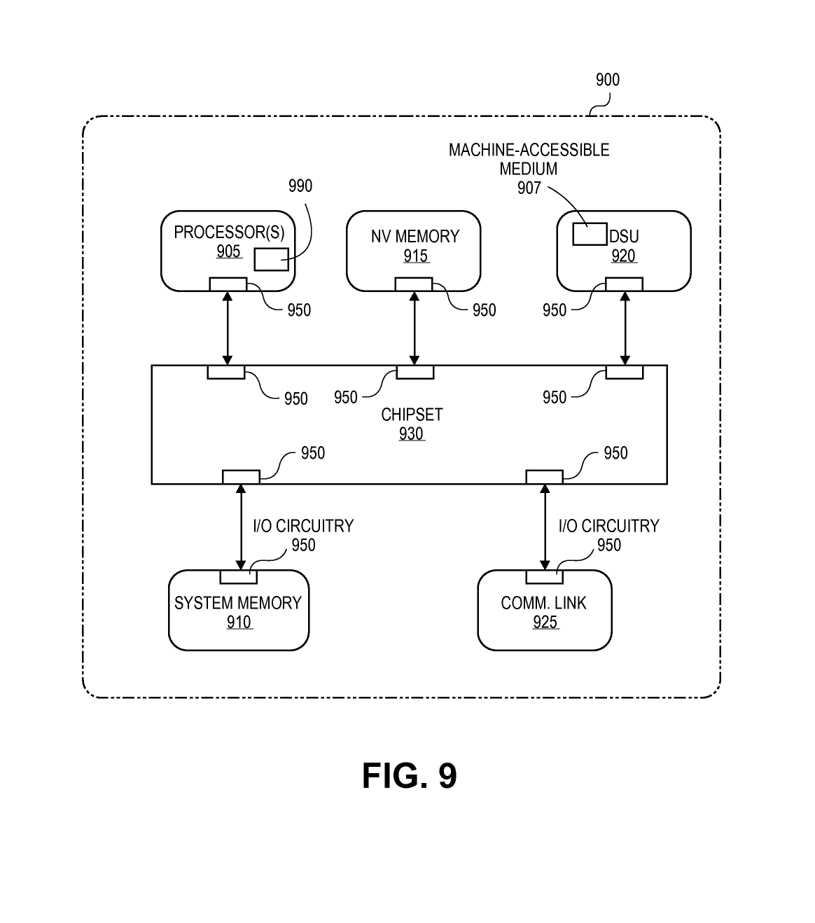

FIG. 9 illustrates a functional block diagram illustrating a system 900 implemented in accordance with one embodiment. The illustrated embodiment of processing system 900 includes one or more processors (or central processing units) 905 having processor architecture 990 (e.g., 200, 300, 400, 500), system memory 910, nonvolatile (“NV”) memory 915, a data storage unit (“DSU”) 920, a communication link 925, and a chipset 930. The illustrated processing system 900 may represent any computing system including a desktop computer, a notebook computer, a workstation, a handheld computer, a server, a blade server, or the like.

The elements of processing system 900 are interconnected as follows. Processor(s) 905 is communicatively coupled to system memory 910, NV memory 915, DSU 920, and communication link 925, via chipset 930 to send and to receive instructions or data thereto/therefrom. In one embodiment, NV memory 915 is a flash memory device. In other embodiments, NV memory 915 includes any one of read only memory (“ROM”), programmable ROM, erasable programmable ROM, electrically erasable programmable ROM, or the like. In one embodiment, system memory 910 includes random access memory (“RAM”), such as dynamic RAM (“DRAM”), synchronous DRAM, (“SDRAM”), double data rate SDRAM (“DDR SDRAM”), static RAM (“SRAM”), and the like. DSU 920 represents any storage device for software data, applications, and/or operating systems, but will most typically be a nonvolatile storage device. DSU 920 may optionally include one or more of an integrated drive electronic (“IDE”) hard disk, an enhanced IDE (“EIDE”) hard disk, a redundant array of independent disks (“RAID”), a small computer system interface (“SCSI”) hard disk, and the like. Although DSU 920 is illustrated as internal to processing system 900, DSU 920 may be externally coupled to processing system 900. Communication link 925 may couple processing system 900 to a network such that processing system 900 may communicate over the network with one or more other computers. Communication link 925 may include a modem, an Ethernet card, a Gigabit Ethernet card, Universal Serial Bus (“USB”) port, a wireless network interface card, a fiber optic interface, or the like.

The DSU 920 may include a machine-accessible medium 907 on which is stored one or more sets of instructions (e.g., software) embodying any one or more of the methods or functions described herein. The software may also reside, completely or at least partially, within the processor(s) 905 during execution thereof by the processor(s) 905, the processor(s) 905 also constituting machine-accessible storage media.

While the machine-accessible medium 907 is shown in an exemplary embodiment to be a single medium, the term “machine-accessible medium” should be taken to include a single medium or multiple media (e.g., a centralized or distributed database, and/or associated caches and servers) that store the one or more sets of instructions. The term “machine-accessible medium” shall also be taken to include any medium that is capable of storing, encoding or carrying a set of instructions for execution by the machine and that cause the machine to perform any one or more of the methodologies of embodiments of the present invention. The term “machine-accessible medium” shall accordingly be taken to include, but not be limited to, solid-state memories, optical, and magnetic media.

Thus, a machine-accessible medium includes any mechanism that provides (i.e., stores and/or transmits) information in a form accessible by a machine (e.g., a computer, network device, personal digital assistant, manufacturing tool, any device with a set of one or more processors, etc.). For example, a machine-accessible medium includes recordable/non-recordable media (e.g., read only memory (ROM); random access memory (RAM); magnetic disk storage media; optical storage media; flash memory devices; etc.), as well as electrical, optical, acoustical or other forms of propagated signals (e.g., carrier waves, infrared signals, digital signals, etc.); etc.

As illustrated in FIG. 9, each of the subcomponents of processing system 900 includes input/output (“I/O”) circuitry 950 for communication with each other. I/O circuitry 950 may include impedance matching circuitry that may be adjusted to achieve a desired input impedance thereby reducing signal reflections and interference between the subcomponents. In one embodiment, the PLL architecture 900 (e.g., PLL architecture 100) may be included within various digital systems. For example, the PLL architecture 990 may be included within the processor(s) 905 and/or communicatively coupled to the processor(s) to provide a flexible clock source. The clock source may be provided to state elements for the processors(s) 905.

It should be appreciated that various other elements of processing system 900 have been excluded from FIG. 9 and this discussion for the purposes of clarity. For example, processing system 900 may further include a graphics card, additional DSUs, other persistent data storage devices, and the like. Chipset 930 may also include a system bus and various other data buses for interconnecting subcomponents, such as a memory controller hub and an input/output (“I/O”) controller hub, as well as, include data buses (e.g., peripheral component interconnect bus) for connecting peripheral devices to chipset 930. Correspondingly, processing system 900 may operate without one or more of the elements illustrated. For example, processing system 900 need not include DSU 920.

In one embodiment, the systems described herein include one or more processors, which include a translation lookaside buffer (TLB). The TLB includes a number of ports for mapping virtual addresses to physical addresses. A first cache storage is coupled to the TLB. The first cache storage receives a physical address associated with a speculative load instruction when the speculative load instruction hits the TLB. A second cache storage is coupled to the first cache storage. The second cache storage to store data including data associated with a physical address that is associated with the speculative load instruction. The one or more processors are configured to execute instructions to determine whether the physical address associated with the speculative load instruction is located in the first cache storage, to spontaneously defer the speculative load instruction by setting a bit in a register file when physical address associated with the speculative load instruction is not located in the first cache storage, and to determine whether the physical address associated with the speculative load instruction is located in the second cache storage.

The one or more processors are further configured to execute instructions to send data associated with the physical address from the second cache storage to the first cache storage. The one or more processors are further configured to execute instructions to resteer to recovery code based on a check instruction when the check instruction receives the set bit. The check instruction is not executed if the speculative load is not needed and a pipeline of the one or more processors avoids stalling because the speculation load is deferred.

The processor design described herein includes an aggressive new microarchitecture design. In a specific embodiment, this design contains 8 multi-threaded cores on a single piece of silicon and can issue up to 12 instructions to the execution pipelines per cycle. The 12 pipelines may include 2 M-pipes (Memory), 2 A-pipes (ALU), 2 I-pipes (Integer), 2 F-pipes (Floating-point), 3 B-pipes (Branch), and 1N-pipe (NOP). The number of M-pipes is reduced to 2 from 4 on previous Itanium® processors. As with previous Itanium® processor designs, instructions are issued and retired in order. Memory operations detect any faults before retirement, but they can retire before completion of the memory operation. Instructions that use load target registers delay their execution until the completion of the load. Memory instructions that use the memory results of a store can retire before the store is complete. The cache hierarchy guarantees that such memory operations will complete in the proper order.

The data cache hierarchy may be composed of the following cache levels:

16 KB First Level Data cache (FLD—core private)

256 KB Mid Level Data cache (MLD—core private)

32 MB Last Level instruction and data Cache (LLC—shared across all 8 cores)

The LLC is inclusive of all other caches. All 8 cores may share the LLC. The MLD and FLD are private to a single core. The threads on a particular core share all of the levels of cache. All of the data caches may have 64-byte cache lines. MLD misses typically trigger fetches for the two 64-byte lines that make up an aligned 128-byte block in order to emulate the performance of the 128-byte cache lines of previous Itanium® processors. This last feature is referred to as MLD buddy line prefetching Software that runs on the processor design described herein will be much more likely to contain software data prefetching than would be the case in previous architectures because of the Itanium® architecture's support for and focus on software optimization including software data prefetching. This software data prefetching has been quite successful at boosting performance. In one embodiment, an important software to run on the present processor design will be large enterprise class applications. These applications tend to have large cache and memory footprints and high memory bandwidth needs. Data prefetching, like all forms of speculation, can cause performance loss when the speculation is incorrect. Because of this, minimizing the number of useless data prefetches (data prefetches that don't eliminate a cache miss) is important. Data prefetches consume limited bandwidth into, out of, and between the various levels of the memory hierarchy. Data prefetches displace other lines from caches. Useless data prefetches consume these resources without any benefit and to the detriment of potentially better uses of such resources. In a multi-threaded, multi-core processor as described herein, shared resources like communication links and caches can be very heavily utilized by non-speculative accesses. Large enterprise applications tend to stress these shared resources. In such a system, it is critical to limit the number of useless prefetches to avoid wasting a resource that could have been used by a non-speculative access. Interestingly, software data prefetching techniques tend to produce fewer useless prefetches than many hardware data prefetching techniques. However, due to the dynamic nature of their inputs, hardware data prefetching techniques are capable of generating useful data prefetches that software sometimes can not identify. Software and hardware data prefetching have a variety of other complementary strengths and weaknesses. The present processor design makes software prefetching more effective, adds conservative, highly accurate hardware data prefetching that complements and doesn't hurt software data prefetching, achieves robust performance gains with mean widespread gains with no major losses and few minor losses, and minimizes the design resources required.

It should be appreciated that reference throughout this specification to “one embodiment” or “an embodiment” means that a particular feature, structure or characteristic described in connection with the embodiment is included in at least one embodiment. Therefore, it is emphasized and should be appreciated that two or more references to “an embodiment” or “one embodiment” or “an alternative embodiment” in various portions of this specification are not necessarily all referring to the same embodiment. Furthermore, the particular features, structures or characteristics may be combined as suitable in one or more embodiments.

In the above detailed description of various embodiments, reference is made to the accompanying drawings, which form a part hereof, and in which are shown by way of illustration, and not of limitation, specific embodiments in which the invention may be practiced. In the drawings, like numerals describe substantially similar components throughout the several views. The embodiments illustrated are described in sufficient detail to enable those skilled in to the art to practice the teachings disclosed herein. Other embodiments may be utilized and derived there from, such that structural and logical substitutions and changes may be made without departing from the scope of this disclosure. The following detailed description, therefore, is not to be taken in a limiting sense, and the scope of various embodiments is defined only by the appended claims, along with the full range of equivalents to which such claims are entitled.

What is claimed is:

1. A computer-implemented method, comprising:
determining whether a speculative load instruction encounters a long latency condition;
spontaneously deferring the speculative load instruction if the speculative load instruction encounters the long latency condition;
initiating a prefetch of a translation or of data requiring long latency access if the speculative load instruction encounters the long latency condition; and
determining whether the speculative load instruction is needed.

2. The computer-implemented method of claim 1, wherein the speculative load instruction is associated with a check instruction, wherein determining whether the speculative load instruction is needed comprises executing software code associated with the method and if the software code reaches the check instruction that is associated with a target register of the speculative load instruction, then the speculative load instruction is needed.

3. The computer-implemented method of claim 2, further comprising:
resteering to recovery code if the speculative load instruction is needed, the recovery code to execute a non-speculative version of the load and to wait for the prefetched translation or data that requires long latency access.

4. The computer-implemented method of claim 1, wherein determining whether a speculative load instruction encounters a long latency condition comprises determining whether the speculative load hits or misses a data cache.

5. The computer-implemented method of claim 1, wherein determining whether a speculative load instruction encounters a long latency condition comprises determining whether the speculative load hits or misses a data translation lookaside buffer (TLB).

6. The computer-implemented method of claim 1, wherein spontaneously deferring the speculative load if the speculative load instruction encounters the long latency condition comprises generating a not a thing (NAT) bit that is set in a target register of the speculative load.

7. A machine-accessible medium including data that, when accessed by a machine, cause the machine to perform operations comprising:
determining whether a speculative load instruction encounters a long latency condition;
spontaneously deferring the speculative load instruction if the speculative load instruction encounters the long latency condition;
initiating a prefetch of a translation or of data requiring long latency access if the speculative load instruction encounters the long latency condition; and
determining whether the speculative load instruction is needed.

8. The machine-accessible medium of claim 7, wherein the speculative load instruction is associated with a check instruction, wherein determining whether the speculative load instruction is needed comprises executing software code associated with the method and if the software code reaches the check instruction that is associated with a target register of the speculative load instruction, then the speculative load instruction is needed.

9. The machine-accessible medium of claim 8, the operations further comprising:
resteering to recovery code if the speculative load instruction is needed, the recovery code to execute a non-speculative version of the load and to wait for the prefetched translation or data that requires long latency access.

10. The machine-accessible medium of claim 7, wherein determining whether a speculative load instruction encounters a long latency condition comprises determining whether the speculative load hits or misses a data cache.

11. The machine-accessible medium of claim 7, wherein determining whether a speculative load instruction encounters a long latency condition comprises determining whether the speculative load hits or misses a data translation lookaside buffer (TLB).

12. The machine-accessible medium of claim 7, wherein spontaneously deferring the speculative load if the speculative load instruction encounters the long latency condition comprises generating a not a thing (NAT) bit that is set in a target register of the speculative load.

13. A processor architecture, comprising:
a register file;
a first translation lookaside buffer (TLB) coupled to the register file, the first TLB with a number of ports for mapping virtual addresses to physical addresses;
a second TLB coupled to the first TLB, the second TLB to perform a hardware page walk that is initiated when the load speculative instruction misses the first TLB;
cache storage to store data including a physical address associated with the load speculative instruction; and
processing logic that is configured to determine whether a speculative load instruction encounters a long latency TLB miss of the first TLB, to spontaneously defer the speculative load instruction by setting a bit in the register file if the speculative load instruction encounters the long latency TLB miss, and to initiate a hardware page walk to the second TLB if the speculative load instruction encounters the long latency TLB miss.

14. The processor architecture of claim 13, wherein the speculative load instruction is associated with a check instruction, wherein determining whether the speculative load instruction is needed comprises executing software code with the processing logic and if the software code reaches the check instruction that is associated with a target register of the speculative load instruction, then the speculative load instruction is needed

15. The processor architecture of claim 14, wherein the processing logic is further configured to resteer to recovery code if the speculative load instruction is needed, the recovery code to execute a non-speculative version of the load and to wait for the hardware page walk.

16. The processor architecture of claim 15, wherein the processor architecture avoids stalling for the hardware page walk if the speculative load is not needed.

17. A system, comprising:
one or more processors comprising,
a translation lookaside buffer (TLB), the first TLB with a number of ports for mapping virtual addresses to physical addresses;
a first cache storage coupled to the TLB, the first cache storage to receive a physical address associated with a speculative load instruction when the speculative load instruction hits the TLB; a second cache storage coupled to the first cache storage, the second cache storage to store data including data associated with a physical address that is associated with the speculative load instruction; wherein the one or more processors are configured to execute instructions to determine whether the physical address associated with the speculative load instruction is located in the first cache storage, to spontaneously defer the speculative load instruction by setting a bit in a register file when the physical address is not located in the first cache storage, and to determine whether the physical address associated with the speculative load instruction is located in the second cache storage.

18. The system of claim 17, wherein the one or more processors are further configured to execute instructions to send the data associated with physical address from the second cache storage to the first cache storage.

19. The system of claim 18, wherein the one or more processors are further configured to execute a check instruction, which resteers to recovery code, when the check instruction receives the set bit.

20. The system of claim 19, wherein a pipeline of the one or more processors avoids stalling when the speculation load is deferred.
